(19) United States
(12) Patent Application Publication
(10) Pub. No.: US 2009/0057636 A1
(43) Pub. Date: Mar. 5, 2009

(54) PORTABLE LIFT DEVICE AND SYSTEM

(75) Inventors: Adam DAVIS, Lancaster, PA (US); James FAIRORTH, Lancaster, PA (US); Michael TAIT, Lititz, PA (US); Kevin FLAGG, Adamstown, PA (US)

Correspondence Address: MCNEES WALLACE & NURICK LLC, 100 PINE STREET, P.O. BOX 1166, HARRISBURG, PA, 17108-1166, US

(73) Assignee: TAIT TOWERS INC., Lititz, PA (US)

(21) Appl. No.: 11/848,567

(22) Filed: Aug. 31, 2007

(51) Int. Cl. B66F 7/16; B66F 7/00

(52) U.S. Cl. 254/89 H; 254/93 R

(57) ABSTRACT

A lift device having a lift structure and a control structure. The lift structure includes a plurality of hydraulic cylinders concentrically arranged. Each cylinder includes a first chamber and a second chamber. At least one of the cylinders includes the second chamber being in fluid communication the first chamber of an adjacent cylinder. The cylinders are operably disposed to extend or retract in response to fluid pressure applied to a first chamber of at least one of the cylinders. The control structure is arranged and disposed to apply a control force to at least one of the cylinders to controllably extend or retract the plurality of cylinders. A portable lift system and method for lifting a platform is also disclosed.

### FIELD OF THE INVENTION

The present invention is directed to lift devices. In particular, portable devices that provide controlled lifting of decking or other structures.

### BACKGROUND OF THE INVENTION

Known lift systems utilize a variety of force generating devices, including, for example, mechanical scissor lifts, which utilize a large number mechanical linkages, and single cylinder hydraulic lifts having limited reach and lack lift control.

In theatrical or concert performances, it is frequently desirable to provide lift components to actuate or otherwise lift portions of stages or platforms to enhance the theatrical or concert display. In such lifting applications, smooth, controlled lifting is important to provide sufficient stability for personnel or performers on the lifted structures. In addition, in theatrical or concert performances, it is desirable to utilize portable structures, wherein the lifting mechanisms can be disassembled into sufficiently small components or modules that allow storage and/or transportation of the individual components. Existing lift systems lack portability, lift control and smooth lifting motion.

Portable structures, such as stages or platforms, must be capable of being disassembled into relatively small units that can be loaded onto trucks, airplanes or other vehicles for transport and/or storage. In addition, the structures must be capable of assembly in a short amount of time, by personnel having little or no technical skill. The above benefits must be provided while providing a platform that is capable of holding and/or lifting a large amount of weight and does not sway or bend during use.

What is needed is a lifting device that provides movable lift support to platforms or other stage-like devices, wherein the lifting mechanism is portable and provides a lifting motion that is smooth and controlled.

### SUMMARY OF THE INVENTION

One aspect of the present invention includes a lift device having a lift structure and a control structure. The lift structure includes a plurality of hydraulic cylinders concentrically arranged. Each cylinder includes a first chamber and a second chamber. At least one of the cylinders includes the second chamber being in fluid communication with the first chamber of an adjacent cylinder. The cylinders are operably disposed to extend or retract in response to fluid pressure applied to a first chamber of at least one of the cylinders. The control structure is arranged and disposed to apply a control force to at least one of the cylinders to controllably extend or retract the plurality of cylinders.

Another aspect of the present invention includes a portable lift system having at least one lift module comprising a pressure vessel containing a fluid, a lift structure, a control structure and a frame. The lift structure includes a plurality of hydraulic cylinders concentrically arranged. Each cylinder includes a first chamber and a second chamber. At least one of the cylinders includes the second chamber being in fluid communication with the first chamber of an adjacent cylinder. The cylinders are operably disposed to extend or retract in response to fluid pressure applied to a first chamber of at least one of the cylinders. The control structure is arranged and disposed to apply a control force to at least one of the cylinders to controllably extend or retract the plurality of cylinders. The frame is configured to support the lift structure and control structure. The lift module is configured to be portable.

Still another aspect of the present invention includes a method for elevating a platform. The method includes providing a lift device having a lift structure and a control structure. The lift structure includes a plurality of hydraulic cylinders concentrically arranged. Each cylinder includes a first chamber and a second chamber. At least one of the cylinders includes the second chamber being in fluid communication with the first chamber of an adjacent cylinder. The cylinders are operably disposed to extend or retract in response to fluid pressure applied to a first chamber of at least one of the cylinders. The control structure is arranged and disposed to apply a control force to at least one of the cylinders to controllably extend or retract the plurality of cylinders. Fluid pressure is applied to a first chamber of at least one of the cylinders. A control force is applied to at least one of the cylinders.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a perspective top view of a lift device 100 according to an embodiment of the present invention in a retracted position.

FIG. 2 shows a perspective top view of a lift device 100 according to an embodiment of the present invention in an extended position.

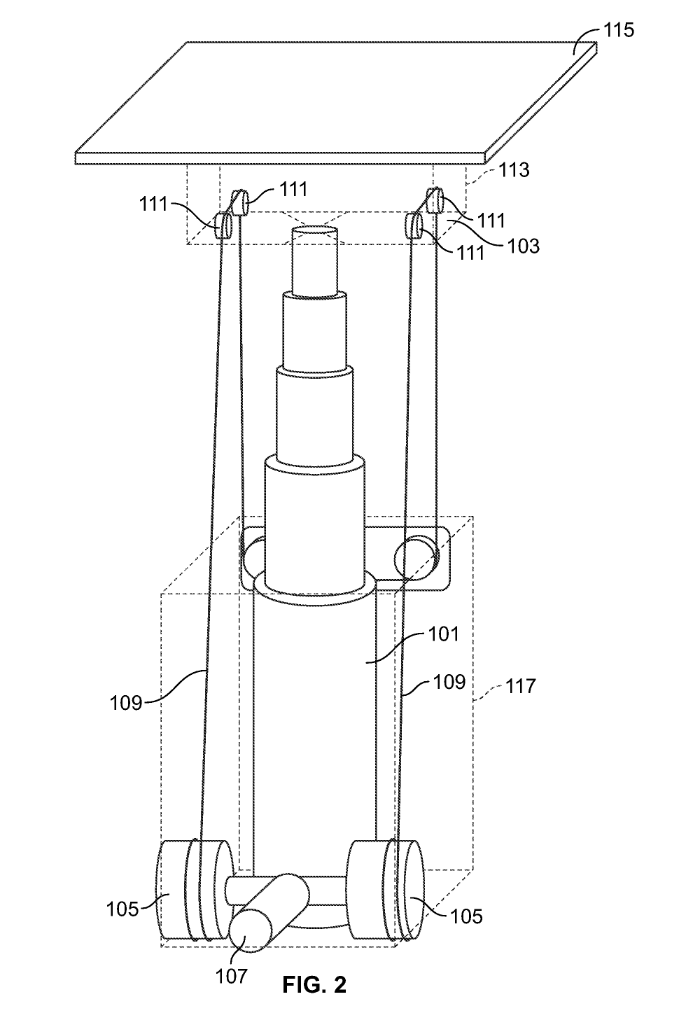

FIG. 3 shows a cross-sectional view of a lift device 100 according to an embodiment of the present invention during extension.

FIG. 4 shows a cross-sectional view of a lift device 100 according to an embodiment of the present invention during retraction.

FIG. 5 shows a portable lift system and platform according to an embodiment of the present invention.

Wherever possible, the same reference numbers are used throughout the drawings to refer to the same or like parts.

### DETAILED DESCRIPTION OF THE INVENTION

One embodiment of the present invention includes a portable hydraulic lift device having a controlled extension, retraction and lifting. Portable, as used herein, includes the ability of components, structures, devices or other assemblies to be detached, broken down (disassembled) or retracted sufficiently to permit transportation and/or storage of the assemblies in conventionally available storage and/or transportation equipment and/or vehicles, such as tractor trailers, aircraft, trains or other storage/transportation vehicles or structures.

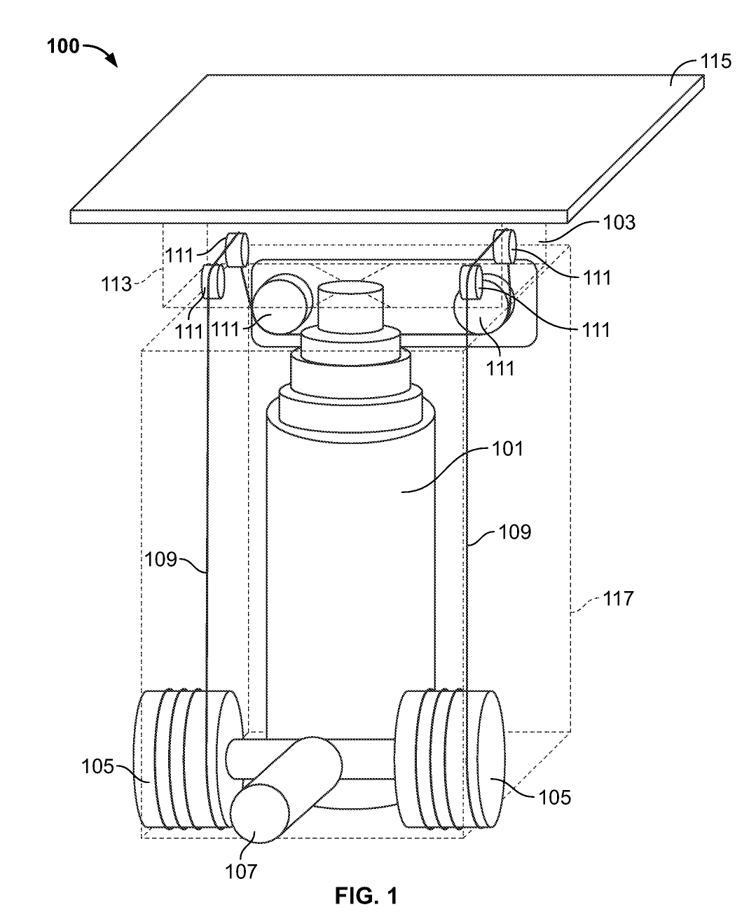

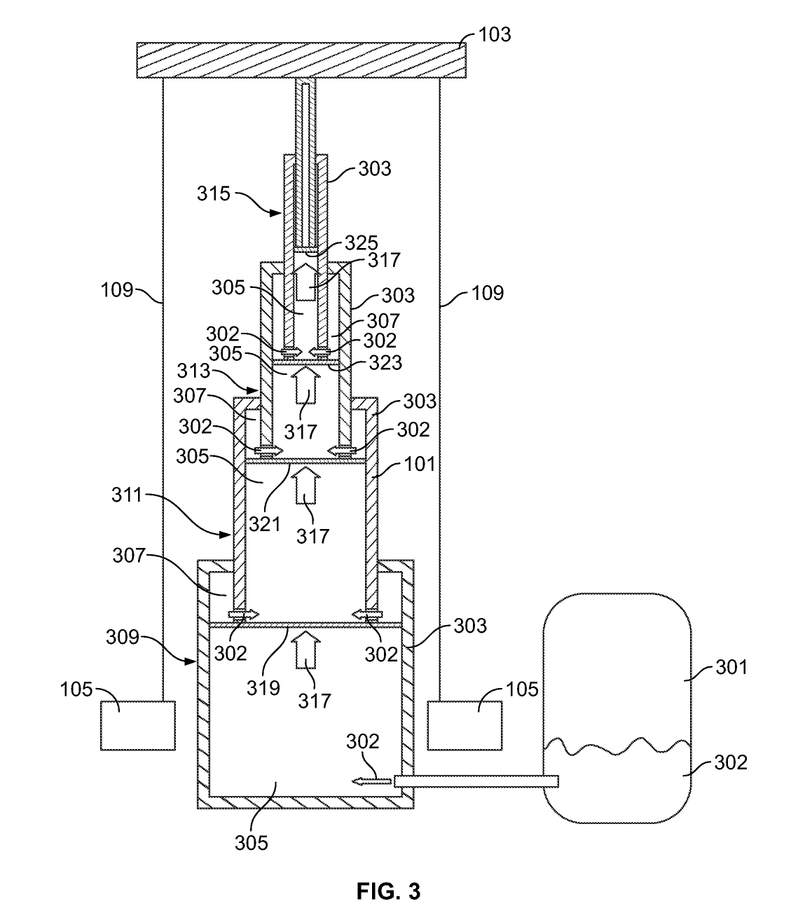

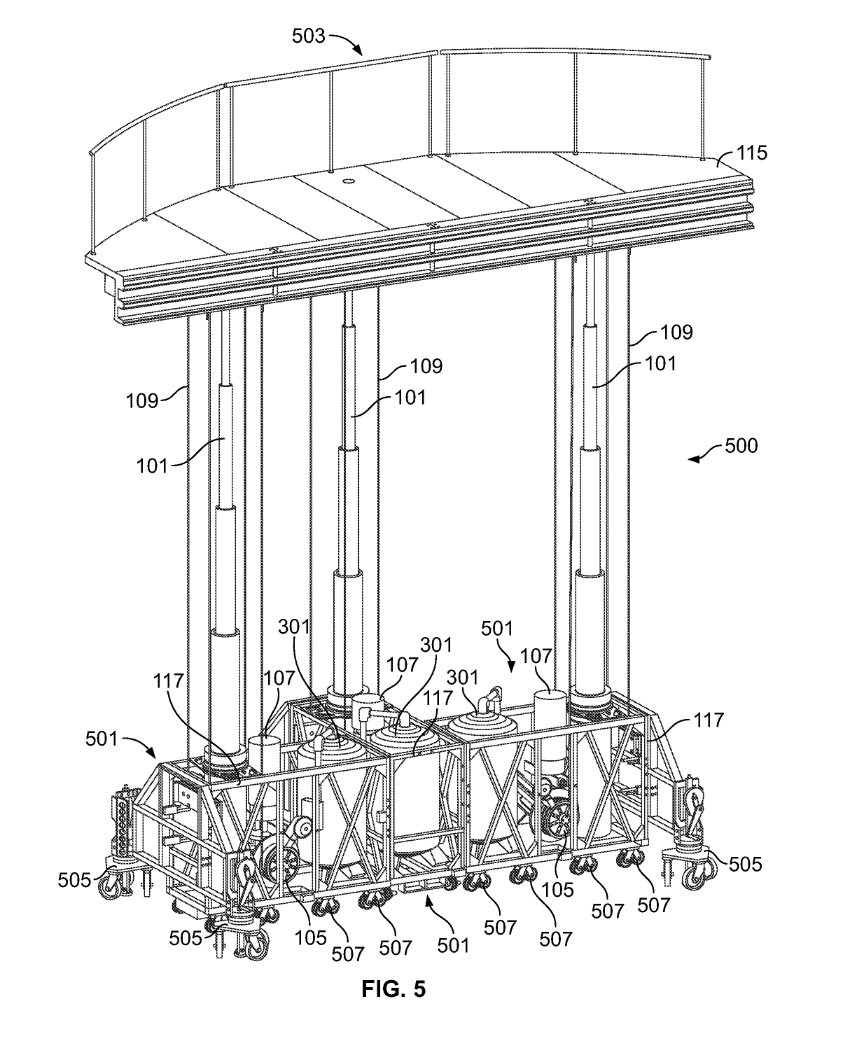

FIG. 1 shows a lift device 100 according to an embodiment of the present invention in a retracted position. The lift device 100 includes a telescoping lift structure 101 having a plurality of stages. The lift device 100 further includes a control structure 103 made up of a series of winches 105 driven by a motor 107. The winches 105 are configured to receive and deploy a cable 109. The motor 107 may be any device capable of driving winches 105, including electrically, hydraulically or mechanically powered motors. In addition, the motor 107 may include gearing, control systems or any other devices or mechanisms desired to drive the winches 105. While a pair of winches 105 is shown, the present invention may include a single winch or more than two winches 105. The lift device 100 further includes a series of pulleys 111 arranged to redirect a tensile force exerted on the cables 109 by the winches 105 driven by motor 107. The lift structure 101 is configured to apply a vertical lifting force to the control structure 103. The lift device 100 further includes a lift control frame 113, which attaches or otherwise contacts the lift structure 101, houses and rotatably carries the pulleys 111 and supports a platform 115. Platform 115 is preferably attached to the lift control frame 113 and is sufficiently supported to allow the arrangement of weight-bearing objects onto the platform 115, including, but not limited to performers and/or equipment relating to a theatrical performance. The lift control frame 113 provides a controlled variable force on the lift device 101. The platform 115 is preferably detachable from the lift control frame 113 during disassembly, storage and/or transportation of the lift device 100. The pulleys 111 may be attached to the lift control frame 113 in any conventional manner and are preferably removable for repair and/or maintenance. Likewise, the various components, including the components of the lift structure 101 and the components of the control structure 103 may be disassembled for storage, transportation, replacement, upgrade, maintenance or repair. The pulleys 111 are preferably disposed at locations within the lift control frame 113 to provide stability to the platform 115 and to further provide control to the extension and/or retraction motion. The lift structure 101 is housed within a module frame 117 in which the motor 107, winches 105, pulleys 111 and any other control and/or operational structures may be disposed. In one embodiment, a reservoir 301 (see e.g., FIGS. 3-5) may further be disposed within frame 117. Frame 117 may include wheels or casters, lift jacks, connections or any other structures or features that may be desirable to add portability and/or functionality to the lift device 100. Frame 117 is preferably configured to allow attachment or cooperation with additional lift devices 100 (see e.g., FIG. 5) to form lift systems, wherein a plurality of lift devices 100 are utilized to provide lifting motion to one or more platforms 115.

To extend the lift device 100 and/or lift the platform 115, a fluid pressure is provided to the lift structure 101. A constant fluid pressure is preferably provided to the lift structure 101 to provide extension of the cylinder stages. Although a constant pressure may be applied, a variable pressure may also be provided and may be in response to a variable load being lifted or to provide additional lift control. Control devices, such as solenoid valves, control valves or other fluid pressure or metering devices may be utilized to provide control during lifting. In addition, safety systems, including emergency relief valves, fail-close and fail-open valves may be installed. The fluid pressure in the lift structure 101 provides a force applied against lift control frame 113. When in the retracted position (see e.g., FIG. 1), in a holding position or in a position otherwise wherein movement is not desired, the control structure 103 reacts to the force provided by the lift structure 101 with an opposed force substantially equal to or greater than the lift force. In order to actuate the lift device 100, the motor 107 may be activated thereby reducing or increasing the force applied by the control structure 103. During extension, the motor 107 is activated to decrease the amount of force the lift control frame 113 exerts against the lift structure 101, resulting in the deployment of the cable 109 and extension of the lift structure 101. The movement resulting from the reduced force of the control structure 103 and the extension of the lift structure 101 is preferably a smooth motion. The controlled extension, retraction and lifting of the lift device 100 is preferably performed with a smooth motion, wherein “smooth”, as herein defined, includes motion substantially free of vibration or jerky movement, including substantially uniform acceleration/deceleration. For example, the motion is preferably sufficiently smooth to permit personnel, such as a performer, to stand substantially unsupported during the extension of the platform.

The upward motion of the lift structure 101 ceases when the motor 107 is deactivated (i.e., the upward force of lift structure 101 equals the reactive force of the lift control frame 113) or the tensile force provided by the cables 109 equals the reactive force of the lift control frame 113. To retract the lift device 100, the motor 107 is activated to rotate the winches 105 in the opposite direction and increase the magnitude of the force applied to the lift structure 101. The motor 107 continues to generate the increased downward force applied to the lift structure 101 until the desired amount of retraction of the structure has been achieved or if the lift structure 101 has been fully retracted.

As shown in FIG. 3, the lift structure 101 is a telescoping series of concentric cylinders 303. The cylinders 303 are coaxially arranged into a first stage 309, a second stage 311, a third stage 313 and a fourth stage 315. The cylinders 303 include a first chamber 305 and a second chamber 307 separated by a respective piston 319, 321, 323, 325. The cylinder 303 in the first stage 309 includes a first chamber 305 in fluid communication with a reservoir 301. The lift structure 101 is extended by directing flow of a fluid 302 to the first stage 309 of the lift structure 101. The fluid 302 is permitted to flow from a reservoir 301 to the first chamber 305 of the first stage 309. The fluid in the reservoir 301 is preferably under pressure. Pressure may be applied to the fluid 302 in any conventional manner, including, but not limited to air pressure applied to the reservoir 301. Suitable pressures for use with the present invention typically include pressure from about 50 to about 110 pounds per square inch (psi). As explained more fully above, the lift structure 101 is permitted to extend upon deployment of the cable 109 and reduction in the downward force exerted on the lift structure 101. As the first stage 309 is permitted to extend, pressurized fluid 302 fills the first chamber 305 of the first stage 309 from the reservoir 301. In response, the force generated by pressurized fluid 302 entering the first chamber 305 urges the piston 319 (i.e., the plate disposed beneath and supporting cylinder 303 of the second stage 311) in upward direction 317.

The upward motion 317 of piston 319 causes fluid 302 from second chamber 307 of the first stage 309 to be forced into the first chamber 305 of the second stage 311. Piston 321 (i.e., the plate disposed beneath and supporting cylinder 303 of the third stage 313) is urged in an upward direction 317 by fluid pressure in the first chamber 305 of the second stage 311.

The upward motion 317 of piston 321 upward forces fluid 302 from the second chamber 307 of the second stage 311 into the first chamber 305 of the third stage 313. Piston 323 (i.e., the plate disposed beneath and supporting cylinder 303 of the fourth stage 315) is urged in an upward direction 317 by fluid pressure in the first chamber 305 of the third stage 313.

The upward motion 317 of the cylinder 303 of the third stage 313 upward forces fluid 302 from the second chamber 307 of the third stage 313 into the first chamber 305 of the fourth stage 315. The fluid pressure in the first chamber 305 of the further stage urges piston 325 in an upward direction 317. Piston 325 extends and applies force to control structure 103. Piston 325 may be of hollow or solid construction and provides contact and a lifting force that is applied to the control structure 103. While the invention has been shown with four stages any number of stages may be utilized. Preferably, the extension of the cylinders in the manner described results in a substantially uniform extension of each of the stages 309, 311, 313 and 315, providing an aesthetically pleasing motion. The extension of the telescoping cylinders is thereby substantially uniform, providing a smooth and powerful lifting motion.

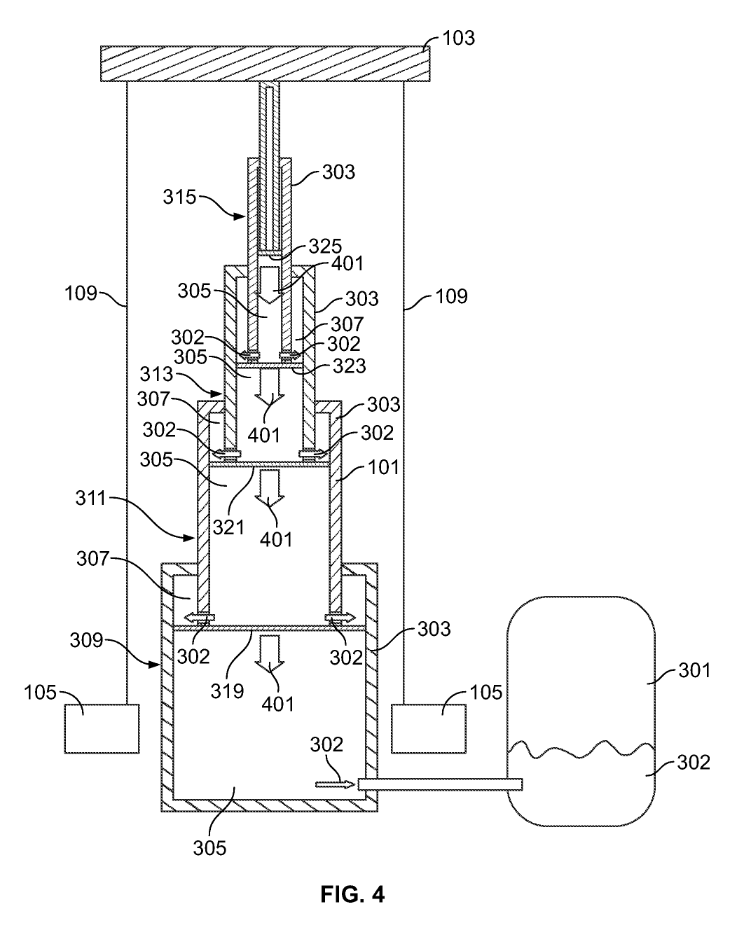

As shown in FIG. 4, in order to retract the cylinder, the fluid 302 flow is reversed, wherein fluid 302 is permitted to enter the reservoir. During retraction, the control structure 103 applies a force to the lift structure 101 sufficient to retract the lift structure. Specifically, the lift control structure 103 is retracted by cables 109, providing a reactive downward force greater than the upward force provided by the lift structure 107. As the fourth stage 315 begins to retract, fluid 302 fills the second chamber 307 of the third stage 313 and the process described above for extension is reversed urging the cylinders 303 in a downward direction 401. Retraction continues until the force generated by control structure 103 equals the reactive force applied by the lift structure 101, or the lift structure 101 is in the fully retracted position.

One embodiment of the present invention includes a lift system 500 utilized for lifting stage elements (see e.g., FIG. 5). In the embodiment shown in FIG. 5, a set of three self-contained portable lift modules 501 are connected together to and controlled to provide a lifted stage component 503. The modules may be arranged in any suitable orientation to each other that is desirable for providing lifting to the stage component 503. Although not so limited, as shown in FIG. 5, the lift system 500 includes modules 501 angularly arranged with respect to to each other. The modules each include a motor 107, winches 105, cable 109, a lift structure 101 and a reservoir 301, housed within a frame 117. The modules 501 further include casters 507 to facilitate easier moving of the modules. In addition modules 501 include jacks 505, which may be provided to provide stability to the lift system, during operation. Other control and/or operational elements, including electronic, hydraulic and/or computer driven control may additionally be present in each of the modules 501, as desired for control of the individual modules 501 and the coordination of a plurality of modules 501. The modules 501 are controlled in cooperation with each other to provide a smooth and reproducible lifting action, suitable for raising performers on elevated stage components 503.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A lift device comprising:
a lift structure comprising a plurality of hydraulic cylinders concentrically arranged, the cylinders each including a first chamber and a second chamber, at least one of the cylinders includes the second chamber being in fluid communication with the first chamber of an adjacent cylinder, the cylinders being operably disposed to extend or retract in response to fluid pressure applied to a first chamber of at least one of the cylinders; and
a control structure arranged and disposed to apply a control force to at least one of the cylinders to controllably extend or retract the plurality of cylinders.

2. The lift device of claim 1, wherein the control structure further comprises at least one winch.

3. The lift device of claim 2, wherein the winch is driven by an electric motor.

4. The lift device of claim 1, wherein the control structure further comprises a platform configured to support personnel.

5. The lift device of claim 1, wherein the control structure utilizes one or more cables arranged and disposed to apply the control force.

6. The lift device of claim 1, wherein the cables are further disposed at locations to maintain stability of the control structure.

7. The lift device of claim 1, wherein the plurality of hydraulic cylinders comprises at least three cylinders.

8. The lift device of claim 1, wherein a substantially constant fluid pressure is applied to a first chamber of at least one of the cylinders.

9. A portable lift system comprising:
at least one lift module comprising:
a pressure vessel containing a fluid;
a lift structure comprising a plurality of hydraulic cylinders concentrically arranged, the cylinders each including a first chamber and a second chamber, at least one of the cylinders includes the second chamber being in fluid communication with the first chamber of an adjacent cylinder, the cylinders being operably disposed to extend or retract in response to fluid pressure applied to a first chamber of at least one of the cylinders;
a control structure arranged and disposed to apply a control force to at least one of the cylinders to controllably extend or retract the plurality of cylinders;
a frame configured to support the lift structure and control structure; and
wherein the lift module is configured to be portable.

10. The portable lift system of claim 9, wherein the control structure further comprises at least one winch.

11. The portable lift system of claim 10, wherein the winch is driven by an electric motor.

12. The portable lift system of claim 9, wherein the control structure further comprises a platform configured to support personnel.

13. The portable lift system of claim 9, wherein the control structure utilizes one or more cables arranged and disposed to apply the control force.

14. The portable lift system of claim 9, wherein the cables are further disposed at locations to maintain stability of the control structure.

15. The portable lift system of claim 9, wherein the plurality of hydraulic cylinders comprises at least three cylinders.

16. The portable lift system of claim 9, wherein a substantially constant fluid pressure is applied a first chamber of at least one of the cylinders.

17. A method for elevating a platform comprising:
providing a lift device having:
a lift structure comprising a plurality of hydraulic cylinders concentrically arranged, the cylinders each including a first chamber and a second chamber, at least one of the cylinders includes the second chamber being in fluid communication with the first chamber of an adjacent cylinder, the cylinders being operably disposed to extend or retract in response to fluid pressure; and
a control structure arranged and disposed to apply a control force to at least one of the cylinders to controllably extend or retract the plurality of cylinders;
applying the fluid pressure to a first chamber of at least one of the cylinders; and
applying a control force to at least one of the cylinders.

18. The method of claim 17, wherein the control force is sufficiently large to retract the lift structure.

19. The method of claim 17, wherein the control force is sufficiently small to extend the lift structure.

20. The method of claim 17, wherein the fluid force is substantially constant.
